(19) United States
(12) Patent Application Publication
(10) Pub. No.: US 2017/0011616 A1
(43) Pub. Date: Jan. 12, 2017

(54) SECURITY SYSTEM WITH USER CONTROLLED MONITORING

(71) Applicant: DIGITAL MONITORING PRODUCTS, INC., Springfield, MO (US)

(72) Inventors: Rick A. Britton, Springfield, MO (US); Jeffrey M. Britton, Springfield, MO (US); Clayton Lewis Tummons, Springfield, MO (US)

(73) Assignee: DIGITAL MONITORING PRODUCTS, INC., Springfield, MO (US)

(21) Appl. No.: 14/795,281

(22) Filed: Jul. 9, 2015

(51) Int. Cl. G08B 25/00; G06Q 20/14

(52) U.S. Cl. CPC G08B 25/008; G06Q 20/145

(57) ABSTRACT

This disclosure relates to a system configured to facilitate on demand monitoring by a local security monitoring apparatus installed at a location of interest. In some implementations, the system includes the local security monitoring apparatus, a server, a central monitoring station, a user device, and/or other components. The system may be configured to facilitate entry and/or selection of monitoring demand information from a user and/or other users. The monitoring demand information may indicate (e.g., a start time, an end time, a duration, etc.) when the monitoring apparatus should operate in a central monitoring mode (e.g., transmitting indications of alarm events for the location of interest.)

### FIELD OF THE DISCLOSURE

This disclosure relates to a system and method to facilitate on demand monitoring by a monitoring apparatus installed at a location of interest.

### BACKGROUND

Security systems configured to electronically monitor houses, businesses and other locations are known. Typically, responsive to detecting unauthorized entry and/or movement at a house or business, these systems generate an audible alarm and notify an alarm services provider of the unauthorized entry and/or movement. Such monitoring systems usually require a monthly monitoring subscription. The monthly monitoring subscription pays for monitoring of a home and/or other location of interest for an entire month (or longer), whether or not monitoring is needed and/or desired during the whole month. Often, a monthly monitoring subscription is unnecessary and/or undesirable for a user because the user does not need and/or does not want a home and/or other location of interest monitored every day during a month, for example.

### SUMMARY

One aspect of the present disclosure relates to a system and a corresponding method for facilitating on demand monitoring by a monitoring apparatus installed at a location of interest. The system comprises the monitoring apparatus installed at the location of interest, a user device, a central monitoring station, one or more servers including one or more physical hardware processors, and/or other components. The monitoring apparatus may comprise one or more of a control panel, a security sensor, a camera, electronic storage, and/or other components. The monitoring apparatus may be configured to detect alarm events, record event information associated with detected alarm events, transmit indications of detected alarm events and associated event information for the location of interest, and/or perform other functions. The user device (e.g., a mobile computing device associated with a user such as a smartphone, a tablet computer, a laptop, etc.) may be configured to facilitate entry and/or selection of monitoring demand information from the user via a graphical user interface presented to the user, and/or via other methods. The monitoring demand information may indicate that the monitoring apparatus should operate in a central monitoring mode. In the central monitoring mode, the monitoring apparatus may transmit indications of alarm events for the location of interest to the central monitoring station. The central monitoring station may be configured to receive the indications of alarm events and the associated event information for the location of interest, facilitate response activity (e.g., notification of police services, fire services, emergency assistance, etc.), and/or take other actions.

The one or more servers may be configured to receive the monitoring demand information from the user via the user device. The monitoring demand information may include information related to one or more of a monitoring start time, a monitoring end time, a monitoring start date, a monitoring end date, a monitoring duration, and/or other information. The one or more physical hardware processors of the one or more servers may be configured to transmit the received monitoring demand information to the central monitoring station, and/or transmit a confirmation indication to the user device indicating the period of time when alarm events will be detected and the indications will be transmitted. The one or more physical hardware processors of the one or more servers may be configured to cause the monitoring apparatus to switch from operating in a stand-alone mode (e.g., the monitoring apparatus may be armed and monitoring the location of interest but not transmitting any information outside the location of interest, or only to the end user) to operating in the central monitoring mode (e.g., detecting alarm events and/or transmitting the indications of alarm events and the associated event information for the location of interest during the period of time, for example, indicated in the monitoring demand information by the user, to the central monitoring station. It should be noted that causing the monitoring apparatus to operate in the central monitoring mode may or may not include turning the monitoring apparatus on and/or off, and/or arming and/or disarming the monitoring apparatus. In some implementations, for example, the monitoring apparatus may be armed and actively monitoring the location of interest but not transmitting indications of alarm events to any central monitoring locations (e.g., the monitoring apparatus may operate in a stand-alone mode as a stand-alone security system that is on and functioning but not transmitting information outside the location of interest, or only to the end user). Causing the monitoring apparatus to operate in the central monitoring mode may include causing the monitoring apparatus to begin such transmission.

In some implementations, the one or more physical hardware processors of the one or more servers may be configured to detect monitoring patterns in the monitoring demand information over time and prompt the user, via the graphical user interface, to enter and/or select subsequent monitoring demand information, with the prompting being based on the detected patterns. In some implementations, the one or more physical hardware processors of the one or more servers may be configured to detect a typical monitoring start time and a typical monitoring start day of the week (and/or other typical schedule information) and prompt the user to enter and/or select the subsequent monitoring demand information, with the prompting being based on the typical monitoring start time and the typical monitoring start day of the week (and/or the other typical schedule information).

In some implementations, the one or more physical hardware processors of the one or more servers are configured to detect whether the user has entered and/or selected the monitoring demand information during a pre-determined inactivity period of time, and, responsive to the user not entering and/or selecting the monitoring demand information during the inactivity period of time, cause the graphical user interface to query the user to determine whether the user wants the monitoring apparatus to begin detecting alarm events and transmitting the indications of alarm events for the location of interest.

In some implementations, the one or more physical hardware processors of the one or more servers may be configured to monitor a cost of individual instances of on demand monitoring. Responsive to a total cost of the individual instances breaching a billing period monitoring cost, the one or more physical hardware processors of the one or more servers may cause the user device to prompt the user to convert to a calendar date based billing method for a remainder of the billing period.

In some implementations, responsive to the central monitoring station receiving the monitoring demand information, the central monitoring station may transmit the confirmation indication to the user device. In some implementations, responsive to the central monitoring station receiving the monitoring demand information, the central monitoring station begins facilitating response activity to the indications of alarm events for the location of interest during the period of time indicated in the monitoring demand information by the user. In such implementations, the central monitoring station may ignore transmissions from the monitoring apparatus until the monitoring demand information indicates the central monitoring station should begin acting on the transmissions.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to facilitate on demand monitoring of a location of interest by a monitoring apparatus.

FIG. 2 illustrates example views of a graphical user interface presented to a user via an “app” running on a user device.

FIG. 3 illustrates communication between the user device, a server, a local security monitoring apparatus, and a central monitoring station.

FIG. 4 illustrates another example of communication between the user device, the server, the local security monitoring apparatus, and the central monitoring station.

FIG. 5 illustrates a third example of communication between the user device, the server, the local security monitoring apparatus, and the central monitoring station.

FIG. 6 illustrates a method for facilitating on demand monitoring of a location of interest by a monitoring apparatus.

### DETAILED DESCRIPTION

In the following paragraphs, implementations of the present disclosure will be described in detail by way of example with reference to the accompanying drawings, which are not necessarily drawn to scale, and the illustrated components are not necessarily drawn proportionately to one another. Throughout this description, the implementations and examples shown should be considered as exemplars, rather than as limitations on the present disclosure. As used herein, the “present disclosure” refers to any one of the embodiments of the disclosure described herein, and any equivalents. Furthermore, reference to various aspects of the disclosure throughout this document does not mean that all claimed embodiments or methods must include the referenced aspects.

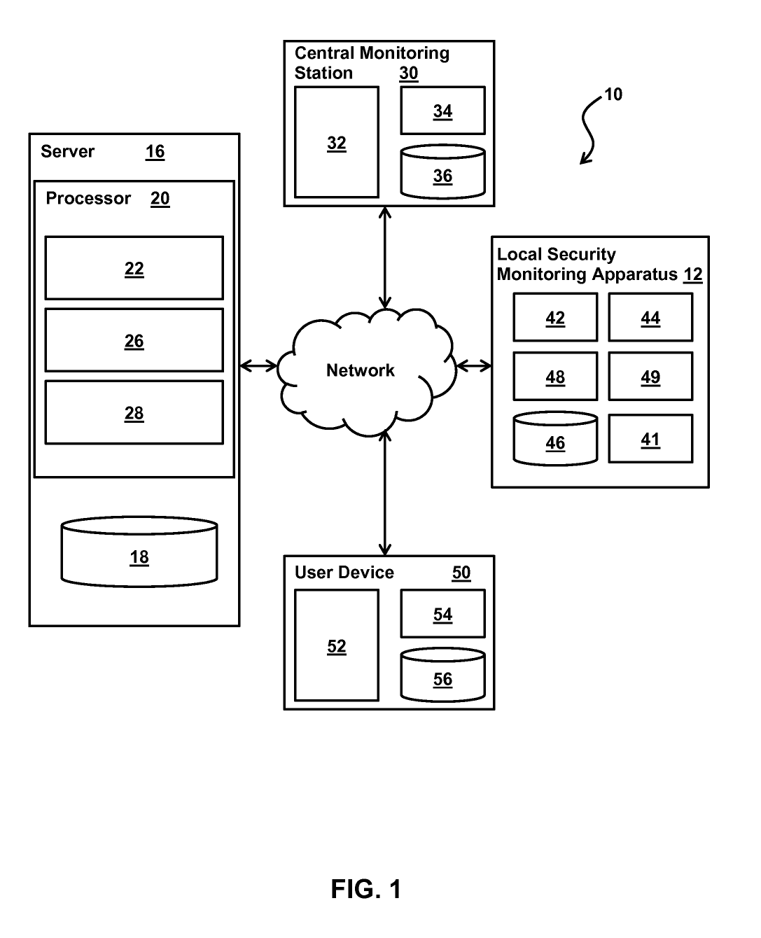

FIG. 1 illustrates a system 10 configured to facilitate on demand monitoring by a local security monitoring apparatus 12 installed at a location of interest. In some implementations, system 10 includes local security monitoring apparatus 12, a server 16, a central monitoring station 30, a user device 50, and/or other components. System 10 may be configured to facilitate entry and/or selection of monitoring demand information from a user and/or other users. The monitoring demand information may indicate that local security monitoring apparatus 12 should operate in a central monitoring mode and/or should switch from operating in a stand-alone mode (e.g., monitoring apparatus 12 may be off, and/or on/armed and monitoring the location of interest but not transmitting any information outside the location of interest) to operating in the central monitoring mode. In the central monitoring mode, local security monitoring apparatus 12 may transmit indications of alarm events for the location of interest to central monitoring station 30, and/or function in other ways. In some implementations, the monitoring demand information may indicate a period of time (e.g., a start time, an end time, a duration, etc.) when monitoring apparatus 12 should detect alarm events and/or transmit indications of alarm events and associated alarm event information (e.g., video images, sensor information, etc.) for the location of interest. The monitoring demand information may be entered and/or selected by the user via a graphical user interface presented to the user on user device 50, and/or in other ways. The graphical user interface may be part of an electronic application (an “app”) presented to the user on user device 50, for example. Central monitoring station 30 may be configured to receive the indications of alarm events for the location of interest during the time selected by the user. System 10 may transmit a confirmation indication back to user device 50 indicating (e.g., confirming) the period of time when alarm events will be detected and the indications/information will be transmitted, and cause monitoring apparatus 12 to detect alarm events, transmit the indications of alarm events and information related to alarm events, and/or bill for monitoring time at the location of interest during the period of time indicated in the monitoring demand information by the user.

System 10 may provide a user the opportunity to have the location of interest selectively monitored only when necessary/desired. For example, a user may not typically require regular monthly ongoing security monitoring of the user's house (e.g., the location of interest). However, the user may desire security monitoring while temporarily away on vacation. Instead of having to pay monthly fees for extended ongoing monitoring (beyond what the user would need for only vacation), system 10 allows the user to pay for monitoring only while the user is away from home. Using system 10, the user may choose a number of days monitoring is desired, set up an off and on monitoring schedule, substantially instantaneously start and/or stop paid monitoring without having to contact a monitoring service to schedule set-up appointments and/or other start up activities, and/or perform other on-demand monitoring activities.

Local security monitoring apparatus 12 may be configured to monitor the security of a location of interest and detect alarm events. Local security monitoring apparatus 12 may be installed at the location of interest, for example. In some implementations, local security monitoring device 12 may include one or more of a user interface 42, a control panel/processor 44, electronic storage 46, a sensor 48, a camera 49, a local sounder 41 (e.g., a speaker and/or other sound generation components configured to generate an audible alarm noise at the location of interest), and/or other components. The location of interest may be and/or include one or more structures such as a house, an office building, a warehouse, a garage, a restaurant and/or other businesses, a storage unit, a museum and/or other public buildings, and/or other structures; geographical areas such as fenced yards (e.g., a backyard, a company vehicle yard, etc.), parks, parking lots, and/or other geographical areas; and/or other locations of interest. Responsive to detecting an alarm event, local security monitoring apparatus 12 may generate an audible alarm noise via local sounder 41 and/or other devices, generate an indication of the detected alarm event for transmission to central monitoring station 30, server 16, and/or other devices, and/or take other actions. An alarm event may include one or more of a perimeter breach, unexpected and/or unauthorized movement, detection of a person or persons in an unauthorized area of the location of interest, detection of smoke, carbon monoxide and/or water, and/or other alarm events. In some implementations, the indication of the detected alarm event may be an electronic signal transmitted from local security monitoring apparatus 12. In some implementations, the indication of the detected alarm event may include video information from camera(s) 49, sensor information from sensor(s) 48, and/or other information.

One or more cameras 49 may be configured to acquire visual information representing the location of interest (e.g., the interior and/or exterior areas of a house and/or other locations of interest). Any number of individual cameras 49 may be positioned at various locations in and/or around the location of interest. Cameras 49 may be configured such that the visual information includes views of exterior areas of the location of interest, one or more interior spaces (e.g., rooms) of the location of interest, and/or other areas to capture visual images of activities that occur at or near the location of interest, and/or in other areas. In some implementations, cameras 49 may include and/or be coupled with a digital video recorder (DVR) system and/or other recording devices configured to record the visual information, the sensor information, and/or other information. In some implementations, the visual information may be received from a third party camera and/or digital video recorder (DVR) system.

Sensors 48 may be configured to generate output signals that convey information related to perimeter breaches, unexpected movement, detection of smoke and/or carbon monoxide and/or other alarm events for the location of interest. Sensors 48 may be configured to generate the output signals substantially continuously, at pre-determined intervals, and/or at other times. Sensors 48 may include proximity sensors (e.g., magnetic proximity sensors), motion sensors, thermal sensors, infrared sensors, pressure sensors, beam fence (e.g., laser fences) sensors, smoke sensors, carbon monoxide sensors, water sensors, and/or other sensors. Any number and/or type of sensors 48 may be placed in and/or around the location of interest.

In some implementations, detecting alarm events may include determining one or more alarm event parameters based on the security video information from cameras 49, the output signals from sensors 48, and/or other information; obtaining alarm event criteria that describe alarm events at the location of interest; and detecting an alarm event responsive to one or more alarm event parameters satisfying one or more alarm event criteria. The one or more alarm event parameters may include, for example determinations of whether doors/windows are open/broken/etc., detection of movement, determination a direction of movement, determining that a given barrier has been breached, determining a temperature, determining an amount of water, smoke and/or carbon dioxide present, and/or other parameters. These parameters may be compared to obtained criteria. The criteria may be obtained from a user, for example, via user device 50, from central monitoring station 30, from server 16, and/or from other sources. The obtained criteria may include binary criteria (e.g., window/door open versus closed, movement versus no movement), thresholds (e.g., a temperature threshold, a water, smoke and/or carbon dioxide threshold level, a pressure level, etc.), relative criteria (e.g., movement in a first direction is permitted while movement in the opposite direction is not permitted), and/or other criteria. For example, local security monitoring apparatus 12 may detect the heat signature of a person moving through a museum based on the output signals from a thermal sensor. Responsive to the person entering a restricted area (e.g., responsive to a determined location parameter satisfying restricted location criteria), local security monitoring device 12 may detect an alarm event and transmit an indication of the alarm event to central monitoring station 30. As another example, local security monitoring apparatus 12 may detect an alarm event responsive to determining that a window was unexpectedly opened (e.g., responsive to a magnetic contact parameter satisfying open window (lack of) magnetic contact criteria) and transmit an indication that the window was unexpectedly opened to central monitoring station 30.

Central monitoring station 30 may include one or more of a user interface 32, a processor 34, electronic storage 36, and/or other components. Central monitoring station 30 may be configured to receive indications of the alarm events and/or information associated with detected alarm events (e.g., information from one or more sensors 48, cameras 49, and/or other information). Central monitoring station 30 may be configured to receive the indications of the alarm events directly from local security monitoring apparatus 12, from local security monitoring apparatus 12 via server 16, and/or by other methods. Responsive to receiving an indication of the alarm event, central monitoring station 30 may request and/or cause one or more dispatch operators to review the received information and determine whether to call for police, fire, and/or other assistance at the location of interest. In some implementations, central monitoring station 30 may be programmed with the electronic addresses of server 16, local security monitoring apparatus 12, user device 50, and/or other devices.

In some implementations, server 16 may include one or more of a processor 20, electronic storage 18, and/or other components. Server 16 may be configured to communicate with one or more user devices 50, central monitoring station 30, local security monitoring apparatus 12, and/or other devices according to a client/server architecture, peer to peer architecture, and/or other architectures. Server 16 may include communication lines, or ports to enable the exchange of information with a network, central monitoring station 30, user device 50, local security monitoring apparatus 12, and/or other computing platforms. Server 16 may include a plurality of processors, electronic storage, hardware, software, and/or firmware components operating together to provide the functionality attributed herein to server 16. For example, server 16 may be implemented by a cloud of computing platforms operating together as a system server. In some implementations, server 16, user device 50, central monitoring station 30, local security monitoring apparatus 12, and/or other components of system 10 may be operatively linked via one or more electronic communication links. For example, such electronic communication links may be established, at least in part, via a network such as the internet and/or other networks such as telephone lines, radio systems or cellular. It will be appreciated that this is not intended to be limiting, and that the scope of this disclosure includes implementations in which servers, user devices, a central monitoring station, a local security monitoring apparatus, and/or other devices may be operatively linked via some other communication media.

Processor 20 may be configured to provide information processing capabilities in server 16 and/or system 10. As such, processor 20 may comprise one or more of a digital processor, an analog processor, a digital circuit designed to process information, an analog circuit designed to process information, a state machine, other hardware processors, and/or other mechanisms for electronically processing information. Although processor 20 is shown in FIG. 1 as a single entity, this is for illustrative purposes only. In some implementations, processor 20 may comprise a plurality of processing units. These processing units may be physically located within the same device (e.g., server 16, or processor 20 may represent processing functionality of a plurality of devices operating in coordination (e.g., server 16, user device 50, local security monitoring apparatus 12, central monitoring station 30).

Processor 20 may be configured to execute computer program components. The computer program components may be configured to enable an expert, a user, and/or other users associated with user device 50, central monitoring station 30, and/or local security monitoring apparatus 12 to interface with processor 20, and/or other components of system 10, and/or provide other functionality attributed herein to processor 20. The computer program components may include a demand information component 22, a communication component 26, a monitoring component 28, and/or other components. Processor 20 may be configured to execute components 22, 26, and/or 28 by software; hardware; firmware; some combination of software, hardware, and/or firmware; and/or other mechanisms for configuring processing capabilities on processor 20.

It should be appreciated that although components 22, 26, and 28 are illustrated in FIG. 1 as being co-located within a single processing unit, in implementations in which processor 20 comprises multiple processing units, one or more of components 22, 26, and/or 28 may be located remotely from the other components (e.g., such as within central monitoring station 30, monitoring apparatus 12, user device 50, and/or other devices). The description of the functionality provided by the different components 22, 26, and/or 28 described herein is for illustrative purposes, and is not intended to be limiting, as any of components 22, 26, and/or 28 may provide more or less functionality than is described. For example, one or more of components 22, 26, and/or 28 may be eliminated, and some or all of its functionality may be provided by other components 22, 26, and/or 28. As another example, processor 20 may be configured to execute one or more additional components that may perform some or all of the functionality attributed below to one of components 22, 26, and/or 28. In some implementations, one or more of components 22, 26, and/or 28 may be executed by a processor incorporated in user device 50, central monitoring station 30, local security monitoring apparatus 12, and/or other components of system 10.

Demand information component 22 may be configured to receive monitoring demand information from a user. The monitoring demand information may be received via a graphical user interface presented to the user on user device 50 and/or by other methods. The monitoring demand information may indicate that local security monitoring apparatus 12 should operate in the central monitoring mode, wherein local security monitoring apparatus 12 transmits indications of alarm events and any associated alarm event information to central monitoring station 30. In some implementations, the monitoring demand information may indicate local security monitoring apparatus 12 should switch from operating in the stand-alone mode to operating in the central monitoring mode. In some implementations, the monitoring demand information may indicate a period of time when monitoring apparatus 12 should detect alarm events and/or transmit indications of alarm events and/or associated alarm event information (e.g., camera images, sensor information, etc.) for the location of interest. The monitoring demand information may include information related to one or more of a monitoring start time, a monitoring end time, a monitoring start date, a monitoring end date, a monitoring duration, and/or other information, for example.

Causing local security monitoring apparatus 12 to operate in the central monitoring mode may or may not include turning local security monitoring apparatus on and/or off, and/or arming and/or disarming local security monitoring apparatus 12. In some implementations, for example, local security monitoring apparatus 12 may be armed and/or actively monitoring the location of interest (e.g., in the stand-alone monitoring mode) but not transmitting indications of alarm events to any remote locations. Monitoring apparatus 12 may operate as a stand-alone security system that is on and functioning but just not transmitting information outside the location of interest. Causing the monitoring apparatus to operate in the central monitoring mode may include causing the monitoring apparatus to begin such transmission (e.g., at a specific time, for a specific duration of time, etc.).

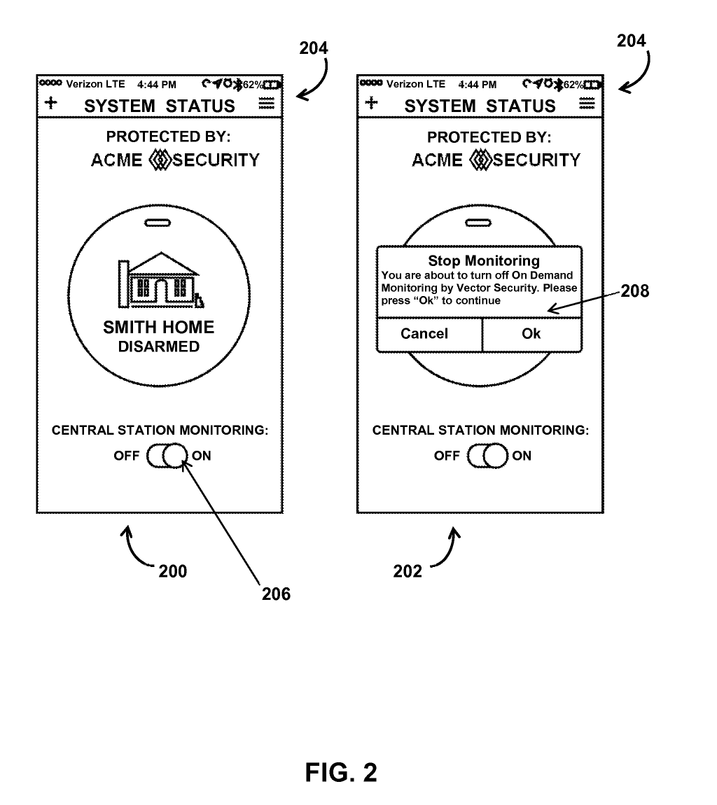

In some implementations, demand information component 22 may be configured to facilitate and/or cause presentation of the graphical user interface on user device 50. As described above, the graphical user interface may be presented to a user on user device 50 via an electronic application (an “app”), for example. The graphical user interface may include one or more views and/or one or more fields within an individual one of the one or more views configured to receive entry and/or selection of the monitoring demand information. For, example, FIG. 2 illustrates example views 200, 202 of a graphical user interface 204 presented to a user via an “app” running on user device 50 (not shown in FIG. 2). FIG. 2 also illustrates two fields 206, 208 for entering and/or selecting monitoring demand information. In the example shown in FIG. 2, entering and/or selecting monitoring demand information includes toggling a button presented to the user between an “on” position (e.g., to turn monitoring on) and an “off” position (e.g., to turn monitoring off). This is not intended to be limiting. In some implementations, one or more fields of graphical user interface 204 may include fields configured for entry and/or selection of calendar information (e.g., textual entry and/or manual selection via drop down boxes etc. of dates, times, durations, etc.) that indicates when (e.g., dates/times) the user wants the location of interest monitored, how long the user wants the location of interest monitored, and/or indicates other information.

In some implementations, local security monitoring apparatus 12 may be configured to automatically cease operation in the central monitoring mode responsive to the monitoring time indicated by the user expiring, responsive to the user indicating via the graphical user interface that the monitoring should be turned off, responsive to a command from server 16, responsive to a command from central monitoring station 30, and/or responsive to other actions.

In some implementations, demand information component 22 (FIG. 1) may be configured to facilitate and/or cause presentation of one or more views (not shown in FIG. 2) of the graphical user interface on user device 50 that facilitate purchase of monitoring days, and/or other monitoring increments of time. In some implementations, responsive to the user turning monitoring on (e.g., as shown in FIG. 2), demand information component 22 (FIG. 1) may track monitoring time while monitoring is on (e.g., until the user turns monitoring off as shown in FIG. 2 for example) and facilitate billing the user for the monitored time (e.g., the amount of time local security monitoring apparatus 12 is in the central monitoring mode). In some implementations, responsive to the user turning monitoring “on” (e.g., as shown in FIG. 2), demand information component 22 may facilitate presentation of one or more views and/or fields that prompt the user to enter and/or select a desired amount/duration of monitoring and/or other information (e.g., how long the user wants local security monitoring apparatus 12 in the central monitoring mode). In some implementations, demand information component 22 may facilitate purchase of monitoring in one day increments and/or other increments (e.g., prior to monitoring being turned on and/or at other times). For example, a user may purchase three days of monitoring (this number of days is not intended to be limiting). The monitoring days may begin when the user selects “on” as shown in FIG. 2, at a selected future time (e.g., beginning a number of days in the future), and/or at other times. The monitoring may be selected to occur on consecutive days, one day at a time on preselected days, and/or on any other schedule selected by the user. In some implementations, the monitoring days may remain in a “bank” of days, for example stored in electronic storage 18, 36, 46, and/or 56 (FIG. 1) on server 16, in central monitoring station 30, in local security monitoring apparatus 12, on user device 50, and/or in other locations. In this example, responsive to a user turning monitoring “off” (e.g., as shown in FIG. 2) before completion of the purchased monitoring period, demand information component 22 may ensure any remaining incremental monitoring purchases remain in the “bank” of days. In some implementations, when such a monitoring period expires (e.g., the “bank” of days is empty), demand information component 22 may cause graphical user interface 204 to indicate to the user that the on-demand monitoring period has expired, and/or demand information component 22 may take other actions. In some implementations, the system will allow the user to select additional monitoring and the number of days used may be accumulated and charged at a later time.

Returning to FIG. 1, communication component 26 may be configured to transmit a confirmation indication to user device 50 indicating the period of time when alarm events will be detected and/or the indications of alarm events and the information associated with alarm events will be transmitted to central monitoring station 30 (e.g., indicating when local security monitoring apparatus 12 will be in the central monitoring mode). The information included in the confirmation indication may be determined based on and/or correspond to the monitoring demand information received from the user. The confirmation indication may comprise one or more of an in app message, a text message, an email, a phone call, a tweet, and/or other confirmation indications. Communication component 26 may be configured to cause local security monitoring apparatus 12 to detect alarm events and/or transmit the indications of alarm events along with the associated alarm event information (e.g., camera images, sensor information, etc.) for the location of interest during the period of time indicated in the monitoring demand information by the user to central monitoring station 30. For example, responsive to receiving an indication that monitoring should be turned on (e.g., as shown in FIG. 2), communication component 26 may communicate (e.g., via an electronic signal) with control panel/processor 44 and/or other components of local security monitoring apparatus 12 to cause local security monitoring apparatus 12 to begin detecting alarm events and transmitting indications of detected alarm event and associated event information to central monitoring station 30.

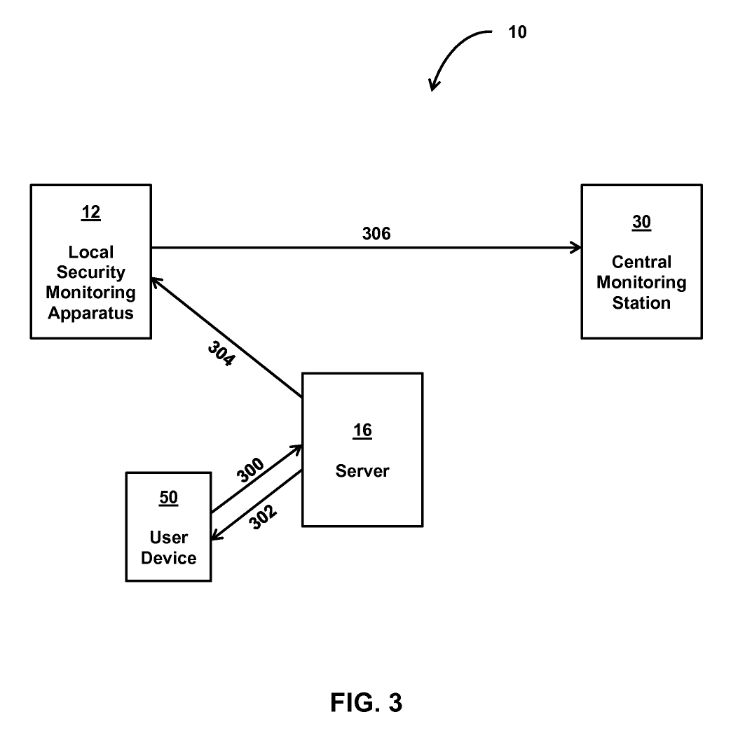

By way of a non-limiting example, FIG. 3 illustrates an example of communication between user device 50, server 16, local security monitoring apparatus 12, and central monitoring station 30. As shown in FIG. 3, a user may turn monitoring “on” via the graphical user interface (for example) on user device 50 (e.g., the user's smartphone). Server 16 may receive the “on” command 300 from user device 50. Server 16 may send 302 a confirmation to the user via user device 50 and cause 304 (e.g., via a transmitted electrical signal) local security monitoring apparatus 12 to begin operating in the central monitoring mode (e.g., transmitting 306 the indications of alarm events along with any associated alarm event information (e.g., camera images, sensor information, etc.) for the location of interest during the period of time indicated in the monitoring demand information by the user to central monitoring station 30.) In some implementations, confirmation 302 and causation 304 may occur at substantially the same time, confirmation 302 may occur before causation 304, and/or causation 304 may occur before confirmation 302. In some implementations, confirmation 302 may be omitted.

In some implementations, communication component 26 may be configured to transmit the received monitoring demand information to central monitoring station 30 and/or other components of system 10 in addition to and/or instead of transmitting the monitoring demand information to local security monitoring apparatus 12. In such implementations, responsive to central monitoring station 30 receiving the monitoring demand information, server 16 (communication component 26) and/or central monitoring station 30 may transmit the confirmation indication to user device 50. In such implementations, responsive to central monitoring station 30 receiving the monitoring demand information, server 16 and/or central monitoring station 30 may cause monitoring apparatus 12 to detect alarm events and/or transmit the indications of alarm events for the location of interest (e.g., operate in the central monitoring mode) during the period of time indicated in the monitoring demand information by the user.

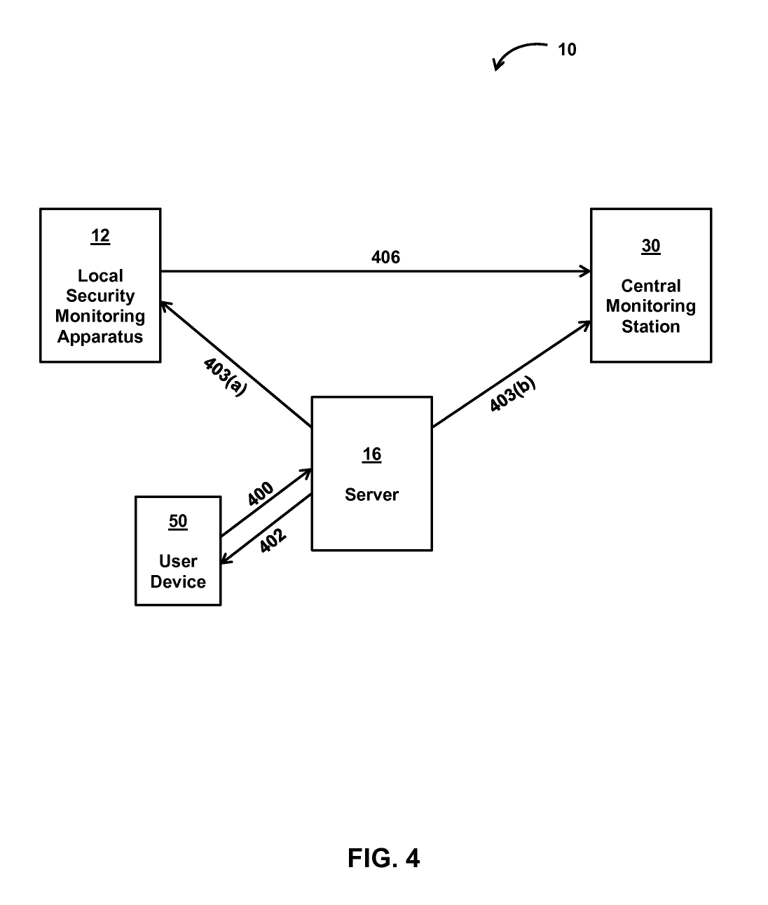

FIG. 4 illustrates another example of communication between user device 50, server 16, local security monitoring apparatus 12, and central monitoring station 30. As shown in FIG. 4, a user may turn monitoring “on” via the graphical user interface (for example) on user device 50 (e.g., the user's smartphone). Server 16 may receive the “on” command 400 from user device 50. Server 16 may send 402 a confirmation to the user via user device 50, send 403(b) the “on” command information to central monitoring station 30, and cause 403(a) local security monitoring apparatus 12 to begin operating in the central monitoring mode (e.g., detecting alarm events and/or transmitting 406 the indications of alarm events along with any associated alarm event information (e.g., camera images, sensor information, etc.) for the location of interest during the period of time indicated in the monitoring demand information by the user to central monitoring station 30.)

In some implementations, local security monitoring apparatus 12 may be configured to detect alarm events and/or transmit indications of the alarm events and the associated alarm event information in an ongoing manner. In such implementations, responsive to central monitoring station 30 receiving the monitoring demand information, central monitoring station 30 may cease ignoring such transmissions and/or begin facilitating response activity (e.g., notification of police services, fire services, emergency assistance, etc.), and/or take other actions. Central monitoring station 30 may begin facilitating the response activity based on the transmitted indications and/or the associated alarm event information during (e.g., at the start of) the time indicated in the monitoring demand information by the user, for example.

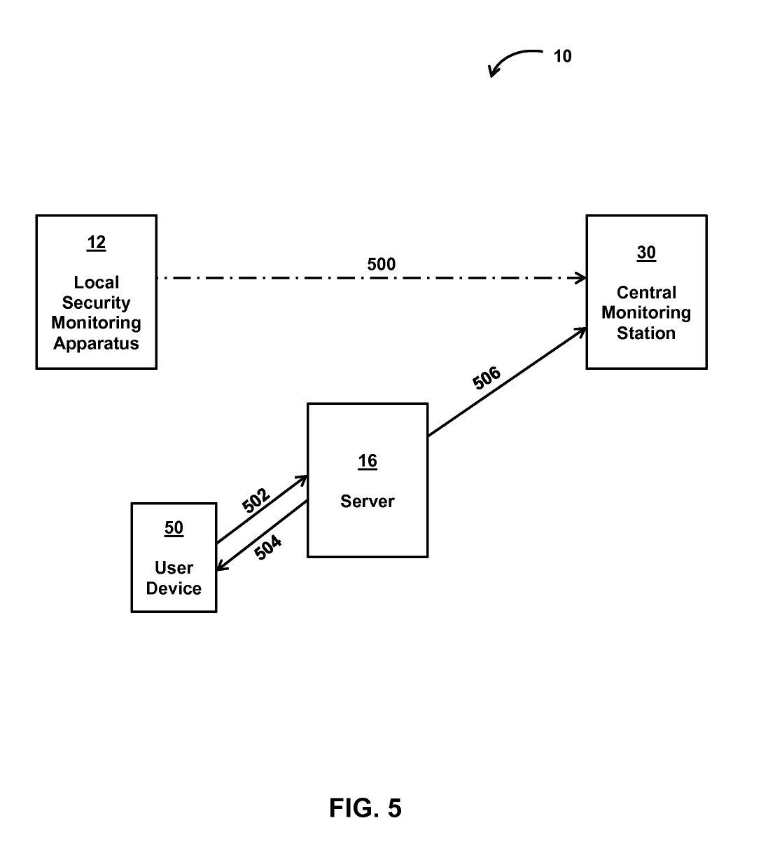

FIG. 5 illustrates a third example of communication between user device 50, server 16, local security monitoring apparatus 12, and central monitoring station 30. As shown in FIG. 5, local security monitoring apparatus 12 may be configured to detect alarm events and transmit 500 indications of the alarm events and the associated alarm event information in an ongoing manner. A user may turn monitoring “on” (e.g., cause local security monitoring apparatus 12 to operate in the central monitoring mode) via the graphical user interface (for example) on user device 50 (e.g., the user's smartphone). Server 16 may receive the “on” command 502 from user device 50. Server 16 may send 504 a confirmation indication to the user via user device 50 and send 506 the “on” command information to central monitoring station 30. In this example, responsive to central monitoring station 30 receiving the “on” command information (e.g., the monitoring demand information), central monitoring station 30 may cease ignoring such ongoing transmissions and/or begin facilitating response activity (e.g., notification of police services, fire services, emergency assistance, etc.), and/or take other actions. In this example, central monitoring station 30 may be configured such that before receiving the “on” command information, information is output from local security monitoring apparatus 12, and may even be received by central monitoring station 30, but then ignored, i.e., not processed (other than to identify the source of the information and determining that the information is not to be monitored) by central monitoring station 30.

It should be noted that the communications described in FIG. 3-5 may be accomplished wirelessly, via wires, and/or by other methods. The communications may be transmitted and/or received by hardware and/or software communications components included in user device 50, server 16, local security monitoring apparatus 12, central monitoring station 30 and/or other components of system 10. The communications may be transmitted via various communications methods such as radio communication, cellular communication, internet communication, WiFi communication, Bluetooth communication, light based communication systems (e.g., fiber optic cables) and/or other communications. In some implementations, one or more of the components of system 10 may be configured to perform handshaking (e.g., sending and/or receiving handshaking requests) and/or other registration and/or communication operations. In some implementations, handshaking requests may be sent and/or received via a Bluetooth link, a WiFi network, a cellular network, the internet, a light based communication system, radio communication, and/or other communication networks. For example, handshaking may be performed by user device 50 and sever 16 and/or other components of system 10.

Returning to FIG. 1, in some implementations, monitoring component 28 may be configured to detect monitoring patterns in the monitoring demand information over time and/or determine other information. Monitoring component 28 may be configured to prompt the user, via the graphical user interface for example, to enter and/or select subsequent monitoring demand information based on the detected patterns and/or based on other information. Monitoring component 28 may detect monitoring patterns based on repeat monitoring requests made by a user at the same or similar times of the day (e.g., every day at 10:00 PM), repeating days of the week (e.g., a user may request monitoring every weekend while they are way), repeating weeks of a month (e.g., the user travels for business during the first week of every month), repeating months and/or seasons of a year (e.g. a user usually request monitoring while the user takes vacation in the summer time), and/or based on other information. In some implementations, monitoring component 28 may determine average, median, and/or other relevant metrics for monitoring start times (of day), stop times (of day), duration, and/or other information, and prompt the user for subsequent monitoring based on such information. For example, monitoring component 28 may be configured to detect a typical monitoring start time and a typical monitoring start day of the week and prompt the user to enter and/or select the subsequent monitoring demand information based on the typical monitoring start time and the typical monitoring start day of the week. In some implementations, monitoring component 28 may prompt the user prior to the typical monitoring start time, and/or after the typical monitoring start time responsive to not receiving the typical monitoring start request (e.g., if a user typically requests monitoring starting every Friday at 5 PM system 10 may prompt the user just before the usual 5 PM start time and/or just after the 5 PM start time if the user has not already requested the typical monitoring).

In some implementations, monitoring component 28 may be configured to detect whether the user and/or other users have entered and/or selected the monitoring demand information during a pre-determined inactivity period of time. The pre-determined inactivity period of time may be a period of time during which the user does not request monitoring (e.g., the user does use the app to request monitoring for one day, one week, one month, one year, etc.) and/or other periods of time. The pre-determined inactivity period of time may be determined at manufacture, determined by a user via the graphical user interface, determined by central monitoring station 30 and/or monitoring component 28 based on previous monitoring requests and/or other information, and/or determined in other ways. Responsive to the user not entering and/or selecting monitoring demand information during the inactivity period of time, monitoring component 28 may be configured to cause the graphical user interface to query the user (and/or query the user in other ways such as with an email, a text message, a phone call, etc.) to determine whether the user wants the monitoring apparatus to begin detecting alarm events and transmitting the indications of alarm events for the location of interest.

In some implementations, monitoring component 28 may be configured to monitor a cost of individual instances of on demand monitoring (e.g., a daily monitoring cost for the individual days of monitoring described above). Responsive to a total cost the individual instances breaching a billing period monitoring cost, monitoring component 28 may cause user device 50 (e.g., via the graphical user interface) to prompt the user to convert to a calendar date based billing method for a remainder of the billing period. For example, as described above, if a user first purchases and uses three monitoring days in a month, and then attempts to purchase three more monitoring days, monitoring component 28 may cause user device 50 to inform (e.g., via a message displayed by the graphical user interface, via a text message, via an email, etc.) the user that the cost of five (for example) or more individual days of monitoring is the same as the cost of a month of monitoring. Monitoring component 28 may then cause user device 50 (e.g., via the graphical user interface) to prompt the user to convert to a monthly billing method for a remainder of the billing month. It should be noted that the daily monitoring billing rate, the billing period monitoring cost, the number of billed monitoring days required to reach the billing period monitoring cost, and/or other information in the example above may be determined at manufacture, determined by central monitoring station 30, determined by server 16, and/or determined in other ways.

User device 50 may be associated with the user and/or other users. In some implementations, user device 50 may include one or more of a user interface 52 (e.g., configured to display the graphical user interface described above), a processor 54, electronic storage 56, and/or other components. In some implementations, user device 50 may be configured to communicate with server 16, central monitoring station 30, local security monitoring apparatus 12, other computing platforms, and/or other devices according to peer-to-peer architecture, client/server architecture, and/or other architectures. User device 50 may include communication lines, and/or ports to enable the exchange of information with a network, other computing platforms, and/or other devices. In some implementations, communication between user device 50 and/or other components of system 10 may be wireless and/or via wires. For example, user device 50 may communicate with server 16, central monitoring station 30, and/or local security monitoring apparatus 12 wirelessly via a Wi-Fi network, via Bluetooth® technology, via a network such as the internet, and/or other wireless methods and may include one or more of a smartphone, a tablet computer, a laptop computer, a desktop computer and/or other computing devices.

Processor 34 in central monitoring station 30, processor 54 in user device 50, and/or processor 44 in local security monitoring device 12 may be configured to provide information processing capability in the individual components of system 10 in which they are included, and/or in system 10 as a whole. As such, processors 34, 44, and/or 54 may include one or more of a digital processor, an analog processor, a digital circuit designed to process information, an analog circuit designed to process information, a state machine, and/or other mechanisms for electronically processing information. Although processors 34, 44, and/or 54 are shown in FIG. 1 as single entities, this is for illustrative purposes only. In some implementations, processor 34, 44, and/or 54 individually include a plurality of processing units. These processing units may be physically located within the same device (e.g., within central monitoring station 30, user device 50, and/or local security monitoring apparatus 12), or processors 34, 44, and/or 54 may represent processing functionality of a plurality of devices operating in coordination. Processors 34, 44, and/or 54 may be configured to enable an expert and/or user associated with user device 50, central monitoring station 30, and/or local security monitoring apparatus 12 to interface with server 16 and/or processor 20, and/or other devices, and/or provide other functionality attributed herein to user device 50, central monitoring station 30, and/or local security monitoring device 12.

In some implementations, user interfaces 32, 42, and 52 may be configured to provide an interface between central monitoring station 30, user device 50, and/or local security monitoring apparatus 12, and a user, a dispatch operator (e.g., located at central monitoring station 30), and/or other users through which the user, a dispatch operator, and/or the other users may provide information to and receive information from central monitoring station 30, user device 50, and/or local security monitoring apparatus 12. This enables data, cues, results, and/or instructions and any other communicable items, collectively referred to as “information,” to be communicated between the user, a dispatch operator, and/or other users and central monitoring station 30, user device 50, local security monitoring apparatus 12, and/or other components of system 10. Examples of interface devices suitable for inclusion in user interfaces 32, 42, and/or 52 comprise a touch screen, a keypad, buttons, switches, a keyboard, knobs, levers, a display screen, speakers, a microphone, an indicator light, an audible alarm, a printer, a computer mouse, and/or other interface devices. In some implementations, user interfaces 32, 42, and/or 52 individually comprise a plurality of separate interfaces (e.g., a display screen, a mouse, and a keyboard). In some implementations, user interfaces 32, 42, and/or 52 comprise one interface (e.g., a touchscreen, a keypad, etc.) that is provided integrally with central monitoring station 30, user device 50, and/or local security monitoring apparatus 12.

It is to be understood that other communication techniques, either hard-wired or wireless, are also contemplated by the present disclosure as user interfaces 32, 42, and/or 52. For example, the present disclosure contemplates that user interfaces 32, 42, and/or 52 may be integrated with a removable storage interface provided by electronic storage 36, 46, and/or 56. In this example, information may be loaded into system 10 from removable storage (e.g., a smart card, a flash drive, a removable disk, etc.) that enables the user to customize the implementation of system 10. Other exemplary input devices and techniques adapted for use as user interfaces 32, 42, and/or 52 comprise, but are not limited to, an RS-232 port, RF link, an IR link, modem (telephone, cable or other). In short, any technique for communicating information with system 10 is contemplated by the present disclosure as user interfaces 32, 42, and/or 52.

In some implementations, electronic storage 18, 36, 46, and/or 56 may comprise electronic storage media that electronically stores information in system 10. Electronic storage 18, 36, 46, and/or 56 may be configured to store software algorithms, clips, images, information determined by processors 20, 34, 44, and/or 54, information received via user interfaces 32, 42, and/or 52, and/or other information that enables system 10 to function as described herein. The electronic storage media of electronic storage 18, 36, 46, and/or 56 may comprise one or both of system storage that is provided integrally (i.e., substantially non-removable) with one or more components of system 10 and/or removable storage that is removably connectable to one or more components of system 10 via, for example, a port (e.g., a USB port, a firewire port, etc.) or a drive (e.g., a disk drive, etc.). Electronic storage 18, 36, 46, and/or 56 may comprise one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 18, 36, 46, and/or 56 may be (in whole or in part) a separate component within one or more components of system 10, or electronic storage 18, 36, 46, and/or 56 may be provided (in whole or in part) integrally with one or more other components of system 10 (e.g., user interfaces 32, 42, and/or 52).

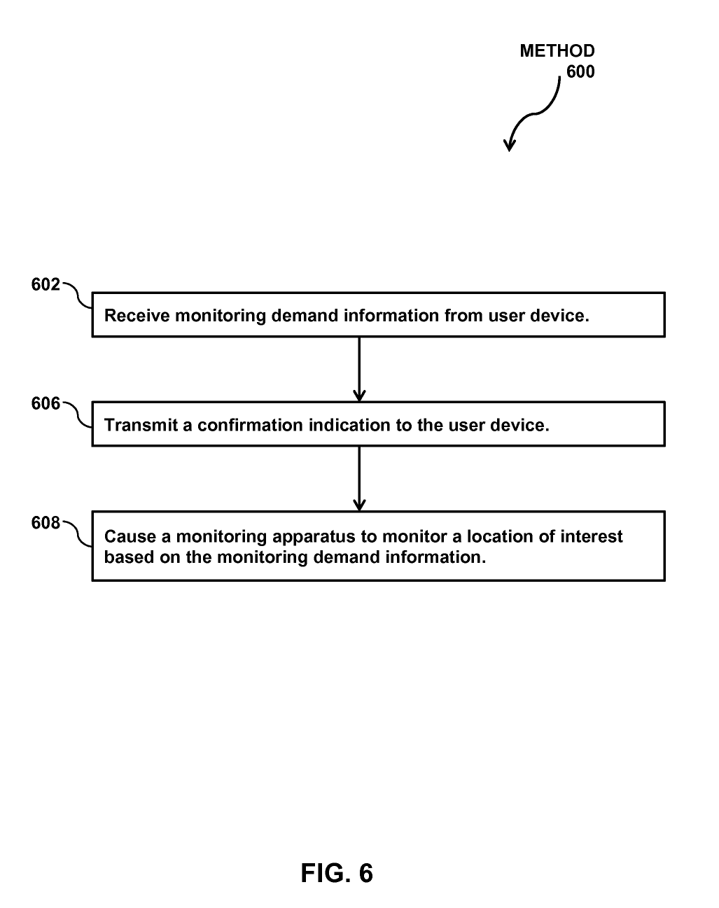

FIG. 6 illustrates a method 600 for facilitating on demand monitoring of a location of interest with a facilitation system. The facilitation system may comprise a monitoring apparatus, a user device, a central monitoring station, one or more servers including one or more physical hardware processors, and/or other components. The monitoring apparatus may be installed at the location of interest and include a control panel, security sensors, video cameras, electronic storage, communication components, and/other components. The monitoring apparatus may be configured to detect alarm events and transmit indications of the alarm events and associated event information to the central monitoring station. The central monitoring station may be configured to receive the indications of alarm events and the associated event information for the location of interest. The server may be located remotely from the central monitoring station and/or other components of the system. The operations of method 600 presented below are intended to be illustrative. In some implementations, method 600 may be accomplished with one or more additional operations not described, and/or without one or more of the operations discussed. Additionally, the order in which the operations of method 600 are illustrated in FIG. 6 and described below is not intended to be limiting.

In some implementations, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium and/or other devices. The one or more processing devices may include one or more devices configured through hardware, firmware, and/or software to be specifically designed for execution of one or more of the operations of method 600.

At an operation 602, monitoring demand information may be received. The monitoring demand information may be received from a user via a graphical user interface presented to the user on the user device and/or by other methods. The monitoring demand information may indicate that the monitoring apparatus should operate in a central monitoring mode wherein the monitoring apparatus transmits indications of alarm events for the location of interest to the central monitoring station. In some implementations, the monitoring demand information may indicate that the monitoring apparatus should switch from operating in a stand-alone mode to operating in the central monitoring mode. The monitoring demand information may indicate a period of time when the monitoring apparatus should detect alarm events for the location of interest and transmit indications of alarm events and associated event information to the central monitoring station. In some implementations, the monitoring demand information includes information related to one or more of a monitoring start time, a monitoring end time, a monitoring start date, a monitoring end date, a monitoring duration, and/or other information.

In some implementations, operation 602 may include monitoring patterns in the monitoring demand information over time and prompting the user, via the graphical user interface for example, to enter and/or select subsequent monitoring demand information. In some implementations, operation 602 may include detecting a typical monitoring start time and a typical monitoring start day of the week and prompting the user to enter and/or select the subsequent monitoring demand information. The prompting may be based on the detected patterns.

In some implementations, operation 602 may include detecting whether the user has entered and/or selected the monitoring demand information during a pre-determined inactivity period of time. Responsive to the user not entering and/or selecting the monitoring demand information during the inactivity period of time, operation 602 may include causing the graphical user interface, for example, to query the user to determine whether the user wants the monitoring apparatus to begin detecting alarm events and transmitting the indications of alarm events for the location of interest.

In some implementations, operation 602 may be performed by a server that is the same as or similar to server 16 (shown in FIG. 1 and described herein).

At an operation 604, a confirmation indication may be transmitted to the user. The confirmation indication may indicate the period of time when alarm events will be detected and the indications and associated event information will be transmitted from the monitoring apparatus to the central monitoring station. In some implementations, responsive to the central monitoring station receiving the monitoring demand information, the central monitoring station transmits the confirmation indication to the user device. In some implementations, operation 604 may be performed by a server that is the same as or similar to server 16 (shown in FIG. 1 and described herein).

At an operation 606, the monitoring apparatus may be caused to operate in the central monitoring mode. In the central monitoring mode, the monitoring apparatus may transmit the indications of alarm events and/or the associated event information for the location of interest as indicated by the user. In some implementations, responsive to the central monitoring station receiving the monitoring demand information, the central monitoring station does not ignore the indications of alarm events and associated event information for the location of interest, but facilitates response activity (e.g., notification of emergency services) for time(s) indicated in the monitoring demand information by the user. In some implementations, operation 606 may be performed by a server that is the same as or similar to server 16 (shown in FIG. 1 and described herein).

In some implementations, operation 606 may include monitoring, with server 16, for example, a cost of individual instances of on demand monitoring. Responsive to a total cost of the individual instances breaching a billing period monitoring cost, server 16 may cause the user device to prompt the user to convert to a calendar date based billing method for a remainder of the billing period.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to facilitate on demand monitoring by a monitoring apparatus installed at a location of interest, the system comprising one or more servers including one or more physical hardware processors configured by computer readable instructions to:
receive monitoring demand information from a user via a graphical user interface presented to the user on a user device, the monitoring demand information indicating that the monitoring apparatus should operate in a central monitoring mode, wherein, in the central monitoring mode, the monitoring apparatus transmits indications of alarm events for the location of interest to a central monitoring station configured to receive the indications; and
cause the monitoring apparatus to switch from operating in a stand-alone mode to operating in the central monitoring mode as indicated in the monitoring demand information by the user.

2. The system of claim 1, wherein the one or more physical hardware processors are further configured to transmit a confirmation indication to the user device indicating when the monitoring apparatus will operate in the central monitoring mode.

3. The system of claim 1, wherein the one or more physical hardware processors are further configured such that the monitoring demand information includes one or more of a monitoring start time, a monitoring end time, a monitoring start date, a monitoring end date, or a monitoring duration.

4. The system of claim 1, wherein the one or more physical hardware processors are further configured to detect monitoring patterns in the monitoring demand information over time and prompt the user, via the graphical user interface, to enter and/or select subsequent monitoring demand information based on the detected patterns.

5. The system of claim 4, wherein the one or more physical hardware processors are further configured to detect a typical monitoring start time and a typical monitoring start day of the week and prompt the user to enter and/or select the subsequent monitoring demand information, the prompting based on the typical monitoring start time and the typical monitoring start day of the week.

6. The system of claim 1, wherein the one or more physical hardware processors are further configured to:
detect whether the user has entered and/or selected the monitoring demand information during a pre-determined inactivity period of time, and,
responsive to the user not entering and/or selecting the monitoring demand information during the inactivity period of time, cause the graphical user interface to query the user to determine whether the user wants the monitoring apparatus to switch from operating in the stand-alone mode to operating in the central monitoring mode.

7. The system of claim 1, wherein the one or more physical hardware processors are included in the central monitoring station.

8. The system of claim 1, wherein the one or more physical hardware processors are included in the user device.

9. The system of claim 1, wherein the one or more physical hardware processors are further configured to monitor a cost of individual instances of on demand monitoring, and, responsive to a total cost the individual instances breaching a billing period monitoring cost, cause the user device to prompt the user to convert to a calendar date based billing method for a remainder of the billing period.

10. A system configured to facilitate on demand monitoring of a location of interest, the system comprising:
a monitoring apparatus installed at the location of interest comprising one or more of a control panel or a security sensor, the monitoring apparatus configured to detect alarm events, record event information associated with detected alarm events, and transmit indications of detected alarm events and the associated event information;
a user device associated with a user configured to facilitate entry and/or selection of monitoring demand information from the user via a graphical user interface presented to the user on the user device, the monitoring demand information indicating that the monitoring apparatus should operate in a central monitoring mode, wherein, in the central monitoring mode, the monitoring apparatus transmits the indications of alarm events and the associated event information;
a central monitoring station configured to receive the indications of alarm events and the associated event information for the location of interest; and
one or more servers including one or more physical hardware processors configured by computer readable instructions to:
receive transmission of the monitoring demand information from the user device; and
cause the monitoring apparatus to switch from operating in a stand-along mode to operating in the central monitoring mode as indicated in the monitoring demand information by the user.

11. A method for facilitating on demand monitoring of a location of interest with a facilitation system, the facilitation system comprising a monitoring apparatus, a user device, a central monitoring station, and one or more servers including one or more physical hardware processors, the method comprising:
receiving, with the one or more physical hardware processors, monitoring demand information from a user via a graphical user interface presented to the user on the user device, the monitoring demand information indicating that the monitoring apparatus should operate in a central monitoring mode, wherein, in the central monitoring mode, the monitoring apparatus transmits indications of alarm events for the location of interest to the central monitoring station; and
causing, with the one or more physical hardware processors, the monitoring apparatus to switch from operating in a stand-alone mode to operating in the central monitoring mode as indicated by the user.

12. The method of claim 11, further comprising transmitting, with the one or more physical hardware processors, a confirmation indication to the user device indicating when the monitoring apparatus will operate in the central monitoring mode.

13. The method of claim 11, wherein the monitoring demand information includes one or more of a monitoring start time, a monitoring end time, a monitoring start date, a monitoring end date, or a monitoring duration.

14. The method of claim 11, further comprising detecting, with the one or more physical hardware processors, monitoring patterns in the monitoring demand information over time and prompting the user, via the graphical user interface, to enter and/or select subsequent monitoring demand information based on the detected patterns.

15. The method of claim 14, further comprising detecting, with the one or more physical hardware processors, a typical monitoring start time and a typical monitoring start day of the week and prompting the user to enter and/or select the subsequent monitoring demand information, the prompting based on the typical monitoring start time and the typical monitoring start day of the week.

16. The method of claim 10, further comprising:
detecting, with the one or more physical hardware processors, whether the user has entered and/or selected the monitoring demand information during a pre-determined inactivity period of time, and,
responsive to the user not entering and/or selecting the monitoring demand information during the inactivity period of time, causing the graphical user interface to query the user to determine whether the user wants the monitoring apparatus to switch from operating in the stand-alone mode and begin operating in the central monitoring mode.

17. The method of claim 10, wherein the one or more physical hardware processors are included in the central monitoring station.

18. The method of claim 10, wherein the one or more physical hardware processors are included in the user device.

19. The method of claim 10, further comprising monitoring, with the one or more physical hardware processors, a cost of individual instances of on demand monitoring, and, responsive to a total cost the individual instances breaching a billing period monitoring cost, causing the user device to prompt the user to convert to a calendar date based billing method for a remainder of the billing period.

20. A system configured to facilitate on demand monitoring by a monitoring apparatus installed at a location of interest, the system comprising one or more servers including one or more physical hardware processors configured by computer readable instructions to:
receive monitoring demand information from a user via a graphical user interface presented to the user on a user device, the monitoring demand information indicating that the monitoring apparatus should operate in a central monitoring mode, wherein, in the central monitoring mode, the monitoring apparatus transmits indications of alarm events for the location of interest to a central monitoring station configured to receive the indications;
transmit the received monitoring demand information to the central monitoring station; and
cause the monitoring apparatus to switch from operating in a stand-alone mode to operating in the central monitoring mode as indicated in the monitoring demand information by the user.

21. The system of claim 20, wherein the one or more physical hardware processors are configured such that, responsive to the central monitoring station receiving the monitoring demand information, the central monitoring station does not ignore the indications of alarm events, but facilitates response activity for the location of interest.

22. The system of claim 20, wherein the one or more physical hardware processors are further configured to transmit a confirmation indication to the user device indicating when the monitoring apparatus will operate in the central monitoring mode.

23. The system of claim 20, wherein the one or more physical hardware processors are further configured such that the monitoring demand information includes one or more of a monitoring start time, a monitoring end time, a monitoring start date, a monitoring end date, or a monitoring duration.

24. A system configured to facilitate on demand monitoring by a monitoring apparatus installed at a location of interest, the system comprising one or more servers including one or more physical hardware processors configured by computer readable instructions to:
receive monitoring demand information from a user via a graphical user interface presented to the user on a user device, the monitoring demand information indicating that a central monitoring station should stop ignoring indications of detected alarm events received for the location of interest from the monitoring apparatus and begin facilitating response activity for the location of interest; and
transmit the received monitoring demand information to the central monitoring station such that the central monitoring station begins facilitating response activity for the location of interest as indicated by the user in the monitoring demand information.

25. The system of claim 24, wherein the one or more physical hardware processors are further configured to transmit a confirmation indication to the user device indicating when the central monitoring station will facilitate response activity for the location of interest.

26. The system of claim 24, wherein the one or more physical hardware processors are further configured such that the monitoring demand information includes one or more of a monitoring start time, a monitoring end time, a monitoring start date, a monitoring end date, or a monitoring duration.
